(19) United States
(12) Patent Application Publication
(10) Pub. No.: US 2018/0017287 A1
(43) Pub. Date: Jan. 18, 2018

(54) WATER OUTLET PIPE COMPONENT

(71) Applicant: A.O. SMITH (CHINA) WATER HEATER CO., LTD., Nanjing, Jiangsu Province (CN)

(72) Inventors: Huaxin WAN, Nanjing (CN); Kaiping AO, Nanjing (CN); Hua WANG, Nanjing (CN); Jianjian CHENG, Nanjing (CN)

(21) Appl. No.: 15/545,615

(22) PCT Filed: Jan. 22, 2016
(86) PCT No.: PCT/CN2016/071759

§ 371 Date: Jul. 21, 2017

(30) Foreign Application Priority Data
Jan. 23, 2015 (CN) 201520051437.8

(51) Int. Cl. F24H 9/00; G05D 23/13

(52) U.S. Cl. CPC F24H 9/0015; G05D 23/1366

(57) ABSTRACT

The invention discloses a water outlet pipe assembly comprising: a pipe body provided with a mounting end capable of being connected with the liner and a free end capable of extending into the liner, wherein a first water inlet is provided at a position of the pipe body close to a lower portion of the liner and enables the water in the lower portion of the liner to enter the pipe body, and a second water inlet is provided at a position of the pipe body close to an upper portion of the liner and enables the water in the upper portion of the liner to enter the pipe body;a blocking element movably provided on the pipe body and a first thermosensitive element provided on the pipe body, the first thermosensitive element can drive the blocking element to move at a preset temperature so as to regulate an opening of the first water inlet and/or the second water inlet; andan elastic returning element provided on the pipe body, the elastic returning element can apply a force to the blocking element for returning the blocking element. The water outlet pipe assembly in this invention has relatively high reliability.

### TECHNICAL FIELD

The invention relates to a drainage device, more particularly to a water outlet pipe assembly.

### BACKGROUND OF THE INVENTION

At present, users propose higher requirements for a water heater in terms of comfortableness, security, durability, etc. in the existing field of water heaters. However, a phenomenon that an outlet water temperature of an existing water heater is excessively high occurs frequently, which has an impact on comfortableness and further security cannot be satisfied.

In order to prevent an output water temperature from being excessively high and thus affect comfortableness, or even the occurrence of cases that users are burned, Chinese invention with publication No. CN203550218U discloses a drainage device of an electric water heater comprising a water outlet tube extending from a water tank bottom for the electric water heater to its top, wherein at least one drainage aperture is provided on the water outlet tube located at a lower portion of the water tank, and the water outlet tube is provided with a thermally controlled switching mechanism controlling a flow area of the drainage aperture. Use of a function of the thermally controlled switching mechanism for automatic adjustment of the output water temperature along with changes in temperature thus prevents the excessively hot water from being drained from the water outlet tube, so as to prevent users from being burned.

To be specific, principal components of the thermally controlled switching mechanism are thermosensitive elements comprising: sleeve pipes or thermosensitive metal sheets or thermosensitive springs or temperature expansion packs. Length of the thermosensitive elements varies with temperature. For instance, as the temperature rises, the length of thermosensitive elements is elongated, and as the temperature goes down, the length of thermosensitive elements is shortened, according to natural elongation or shortening of the thermosensitive elements, the flow area of the drainage aperture is controlled. However, in the case that the thermosensitive elements are in use, its natural elongation amount is generally distinguished from the shortening amount under the identical temperature difference. Usually, the naturally shortened distance is shorter than the elongated distance, as a result, after a number of uses, the thermosensitive elements can be shifted, so that the objective for accurately controlling the flow area of the drainage aperture cannot be achieved. To some extent, the drainage device of the electric water heater has a shortcoming of lower reliability.

### SUMMARY OF THE INVENTION

An object of this invention is to provide a water outlet pipe assembly with high reliability.

The above-mentioned object of this invention can be achieved by means of the following technical solutions:

A water outlet pipe assembly installed in a liner of a water heater, comprising: a pipe body provided with a mounting end capable of being connected with the liner and a free end capable of extending into the liner, wherein a first water inlet is provided at a position of the pipe body close to a lower portion of the liner and enables the water in the lower portion of the liner to enter the pipe body, a second water inlet is provided at a position of the pipe body close to an upper portion of the liner and enables the water in the upper portion of the liner to enter the pipe body; a blocking element movably provided on the pipe body and a first thermosensitive element provided on the pipe body, the first thermosensitive element can drive the blocking element to move at a preset temperature so as to regulate an opening of the first water inlet and/or the second water inlet; and an elastic returning element provided on the pipe body, the elastic returning element can apply a force to the blocking element for returning it.

Further, the blocking element has a first position completely blocking the first water inlet and a second position at least partly opening the first water inlet; the first thermosensitive element can drive the blocking element to move between the first position and the second position; and the elastic returning element can apply the force towards the first position to the blocking element.

Further, the blocking element is of hollow structure and is sleeved with the pipe body.

Further, the pipe body is provided with a stopper which can limit a range of the movement of the blocking element.

Further, the blocking element is of cylindrical shape, provided with an opening, when the blocking element is in the first position, the blocking element completely blocks the first water inlet; and when the blocking element is in the second position, the opening is at least partly communicated with the first water inlet.

Further, the blocking element has a first part for blocking the first water inlet, and a second part provided with a through hole; and when the blocking element is in the second position, the through hole is at least partly communicated with the first water inlet.

Further, the first part has a stopped surface facing the stopper, and when the blocking element is in the first position, the stopped surface is stopped by the stopper.

Further, an end of the second part away from the first part is formed with a peripheral flange; and when the blocking element is in the second position, the peripheral flange is stopped by the stopper.

Further, the blocking element, the first thermosensitive element and the elastic returning element are all provided at interior or exterior of the pipe body.

Further, the first thermosensitive element is a thermosensitive spring.

Further, the thermosensitive spring is provided on a portion for mixing hot water and cold water of the pipe body.

Further, the thermosensitive spring is of a material of nickel-titanium alloy or nickel-titanium-copper alloy.

Further, the first thermosensitive element is of a material of thermosensitive polymer.

Further, the elastic returning element is a return spring whose elastic coefficient is a constant.

Further, when the blocking element is in the second position, the elastic coefficient of the return spring is less than that of the first thermosensitive element.

Further, the elastic returning element is a second thermosensitive element.

Further, the first thermosensitive element is disposed at a position close to the first water inlet, or the first thermosensitive element is disposed at a position close to the second water inlet.

Further, a connector is provided between the first thermosensitive element and the blocking element.

Further, the pipe body is provided with a first limiting portion limiting the first thermosensitive element, and the first thermosensitive element is provided between the first limiting portion and the blocking element; the pipe body is provided with a second limiting portion limiting the elastic returning element, and the elastic returning element is provided between the second limiting portion and the blocking element.

Characteristics and advantages of this invention are that: the water outlet pipe assembly provided with the elastic returning element in this invention can effectively ensure that the blocking element could be returned accurately and therefore is highly reliable over the existing drainage device, on the premise that the function of automatic adjustment of water temperature is achieved. In addition, the limiting portions matching the elastic returning element are further provided in the corresponding positions of the pipe body for a better control on a compression or elongation distance of the first thermosensitive element and the elastic returning element, preventing them from excessive deformation and improving their durability, which further helps to prolong a service life of the entire water outlet pipe assembly.

Furthermore, this invention is simple in structure and cost effective, a water outflowing at constant-temperature can be realized not only by controlling an opening of the first water inlet for mixing cold water into hot water, but also by controlling an opening of the second water inlet for mixing hot water into cold water, or even by controlling the openings of both the first water inlet and the second water inlet.

### BRIEF DESCRIPTION OF THE DRAWINGS

In order to illustrate the technical solutions in embodiments of the present application or in the prior art more clearly, the accompanying drawings desired to be used in descriptions of the embodiments or the prior art can be briefly described below, which apparently are only some embodiments recited in the present application, and further obtaining other accompanying drawings upon those ones would require no creative effort for those skilled in the art.

FIG. 1 is a schematic diagram showing the installation of a water outlet pipe assembly of this invention in a liner;

FIG. 2 is a schematic diagram showing the structure of Example 1 of the water outlet pipe assembly of this invention;

FIG. 3 is a diagram showing the using state of Example 1 of the water outlet pipe assembly of this invention;

FIG. 4 is a schematic diagram showing the structure of Example 2 of the water outlet pipe assembly of this invention;

FIG. 5 is diagram showing the using state of Example 2 of the water outlet pipe assembly of this invention;

FIG. 6 is a sectional view of Example 3 of the water outlet pipe assembly of this invention;

FIG. 7 is a diagram showing the using state of Example 3 of the water outlet pipe assembly of this invention;

FIG. 8 is a schematic diagram showing the structure of Example 4 of the water outlet pipe assembly of this invention;

FIG. 9 is a diagram showing the using state of Example 4 of the water outlet pipe assembly of this invention;

FIG. 10 is a schematic diagram showing the structure of Example 5 of the water outlet pipe assembly of this invention;

FIG. 11 is a diagram showing the using state of Example 5 of the water outlet pipe assembly of this invention;

FIG. 12 is a schematic diagram showing the structure of Example 6 of the water outlet pipe assembly of this invention;

FIG. 13 is a schematic diagram showing the installation of Example 6 of the water outlet pipe assembly of this invention located in the liner; and

FIG. 14 is a diagram showing the using state of Example 6 of the water outlet pipe assembly of this invention.

### DETAILED DESCRIPTION OF THE INVENTION

The technical solution of this invention will be described below in detail with reference to drawings and particular Examples, it should be understood that these Examples are provided solely to illustrate this invention and are not intended to limit the range of this invention. Modifications in equivalent forms of the present invention made by those skilled in the art, upon reading the invention, fall within the range of the appended claims of the present application.

The invention provides a water outlet pipe assembly, which has characteristics of high reliability and so on.

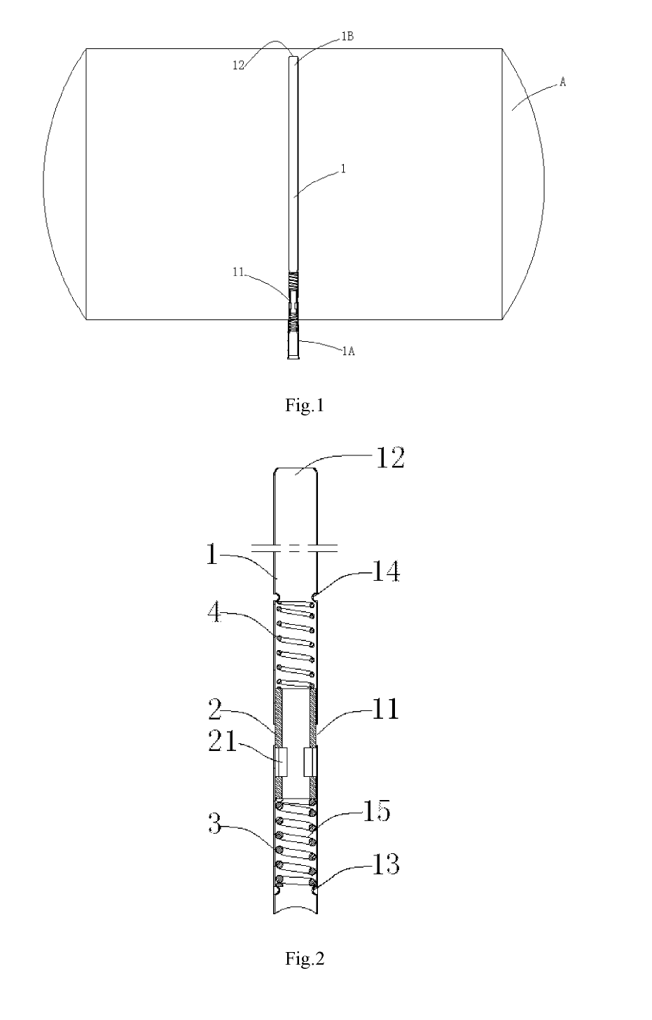

Refer to FIG. 1, which is a schematic diagram showing the installation of the water outlet pipe assembly of this invention in a liner. As shown in FIG. 1, a water outlet pipe assembly of this invention is installed in a liner A of a water heater and comprises a pipe body 1 having a mounting end 1A capable of being connected with the liner A and a free end 1B capable of extending into the liner A.

Refer to FIG. 2, which is a schematic diagram showing the structure of Example 1 of the water outlet pipe assembly of this invention. A first water inlet 11 is provided at a position of the pipe body 1 close to a lower portion of the liner A, and the first water inlet 11 enables the water in the lower portion of the liner A to enter the pipe body 1; a second water inlet 12 is provided at a position of the pipe body 1 close to an upper portion of the liner A, and the second water inlet 12 enables the water in the upper portion of the liner A to enter the pipe body 1; a blocking element 2 is movably provided on the pipe body 1; and a first thermosensitive element 3 is provided on the pipe body 1, and the first thermosensitive element 3 can drive the blocking element 2 to move at a predetermined temperature so as to regulate an opening of the first water inlet 11; and an elastic returning element 4 is provided on the pipe body 1, and the elastic returning element 4 can apply a force to the blocking element 2 for returning it.

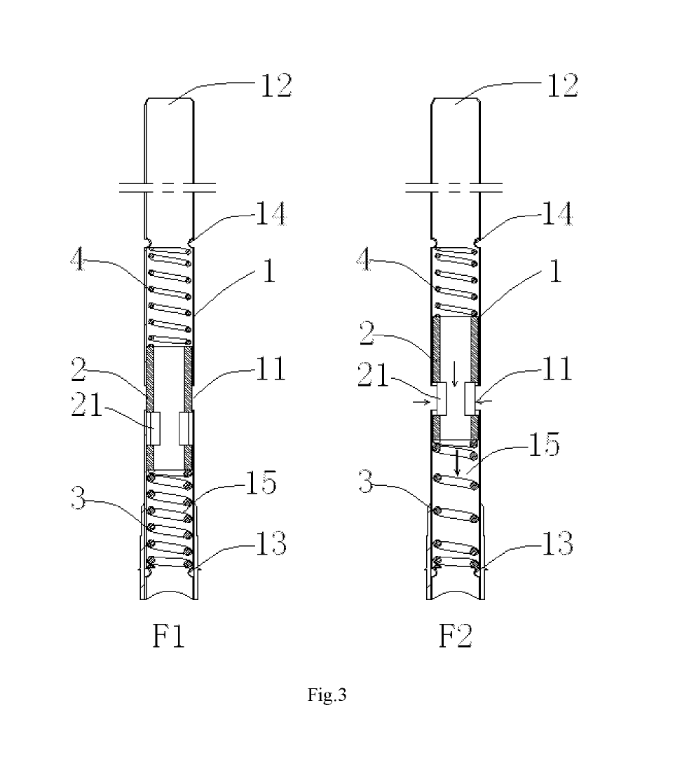

Refer to FIG. 3, which is a diagram showing the using state of Example 1 of the water outlet pipe assembly of this invention. The blocking element 2 has a first position F1 completely blocking the first water inlet 11 and a second position F2 at least partly opening the first water inlet 11; the first thermosensitive element 3 can drive the blocking element 2 to move between the first position F1 and the second position F2; and the elastic returning element 4 can apply the force towards the first position F1 to the blocking element 2.

Applied with the returning force by the elastic returning element 4, the blocking element 2 can be accurately returned to the initial first position F1, thereby ensuring the reliability of the water outlet pipe assembly in use.

Further, as shown in FIG. 2, the blocking element 2 is of hollow structure and is sleeved with the pipe body 1.

For example, the blocking element 2 is of cylindrical shape and can be sleeved inside the pipe body 1, and the blocking element 2 is provided with an opening 21. When the blocking element 2 is in the first position F1, the blocking element 2 completely blocks the first water inlet 11; and when the blocking element 2 is in the second position F2, the opening 21 is at least partly communicated with the first water inlet 11.

The first thermosensitive element 3 and the elastic returning element 4 are disposed inside the pipe body 1.

The pipe body 1 is provided with a first limiting portion 13 limiting the first thermosensitive element 3, and the first thermosensitive element 3 is provided between the first limiting portion 13 and the blocking element 2; the pipe body 1 is provided with a second limiting portion 14 limiting the elastic returning element 4, and the elastic returning element 4 is provided between the second limiting portion 14 and the blocking element 2. The first limiting portion 13 and the second limiting portion 14 are particularly circumferential projections inwardly formed on a pipe wall of the pipe body 1. The first limiting portion 13 and the second limiting portion 14 respectively disposed on the pipe body 1 facilitate to accurately control a compression or elongation distance of the first thermosensitive element 3 and the elastic returning element 4, preventing them from excessive deformation, and therefore achieving good durability, which helps to prolong a service life of the entire water outlet pipe assembly.

The first thermosensitive element 3 may be particularly a thermosensitive spring. In a preferred embodiment, the thermosensitive spring is provided in a position of a portion for mixing hot water and cold water 15 of the pipe body 1 close to the first water inlet 11. When the thermosensitive spring is provided on the portion for mixing hot water and cold water 15, the temperature sensed by the thermosensitive spring is directly consistent with that in the position of an outlet port of a water outlet pipe, which facilitates to accurately and reliably control an output water temperature of the water outlet pipe. When the first thermosensitive element 3 is a thermosensitive spring, its material may be nickel-titanium alloy or nickel-titanium-copper alloy.

Additionally, the first thermosensitive element 3 may particularly be a thermosensitive polymer tube.

The elastic returning element 4 may particularly be a return spring, the elastic coefficient of which is a constant.

When the blocking element 2 is in the second position F2, the elastic coefficient of the return spring is less than that of the first thermosensitive element 3, in order to ensure that the return spring has enough power to return the blocking element 2.

The elastic returning element 4 may also be a second thermosensitive element.

In practice, when the temperature of the water flowing from the second water inlet 12 is higher and reaches a predetermined temperature, the first thermosensitive element 3 drives the blocking element 2 to move from the first position F1 towards the second position F2 to increase the opening of the first water inlet 11, and as the temperature goes down, the first thermosensitive element 3 drives the blocking element 2 to move from the second position F2 towards the first position F1 to reduce the opening of the first water inlet 11. The water outlet pipe assembly in this invention provided with the elastic returning element 4 can effectively ensure that the blocking element 2 could be returned accurately and therefore is highly reliable, on the premise that the function of automatic adjustment of water temperature is achieved.

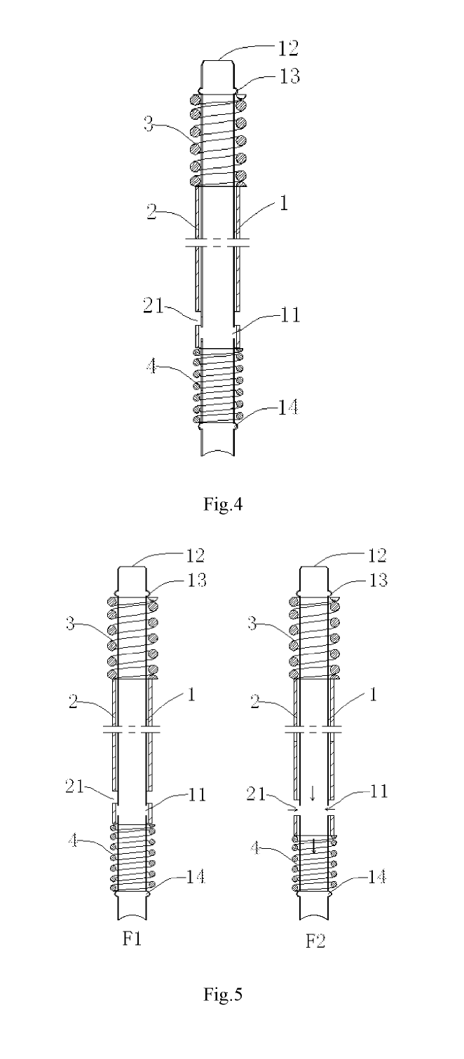

Refer to FIG. 4, which is a schematic diagram showing the structure of Example 2 of the water outlet pipe assembly of this invention. Example 2 differs from Example 1 in that, the blocking element 2, the first thermosensitive element 3 and the elastic returning element 4 are sleeved on the periphery of the pipe body 1. The first limiting portion 13 and the second limiting portion 14 may particularly be circumferential projections outwardly formed on a pipe wall of the pipe body 1. The first thermosensitive element 3 is disposed at a position close to the second water inlet 12. The first thermosensitive element 3 is used for sensing the temperature of the hot water at the second water inlet 12.

Refer to FIG. 5, which is a diagram showing the using state of Example 2 of the water outlet pipe assembly of this invention. The blocking element 2 has a first position F1 completely blocking the first water inlet 11 and a second position F2 at least partly opening the first water inlet 11; the first thermosensitive element 3 can drive the blocking element 2 to move between the first position F1 and the second position F2; the elastic returning element 4 can apply the force towards the first position F1 to the blocking element 2. Applied with the returning force by the elastic returning element 4, the blocking element 2 can be accurately returned to the initial first position F1, thereby ensuring the reliability of the water outlet pipe assembly in use.

In practice, when the temperature of the water flowing from the second water inlet 12 is higher and reaches a predetermined temperature, the first thermosensitive element 3 drives the blocking element 2 to move from the first position F1 towards the second position F2 to increase the opening of the second water inlet 12, and as the temperature goes down, the first thermosensitive element 3 drives the blocking element 2 to move from the second position F2 towards the first position F1 to decrease the opening of the second water inlet 12. The water outlet pipe assembly in this invention provided with the elastic returning element 4 can effectively ensure that the blocking element 2 could be returned accurately and therefore is highly reliable, on the premise that the function of automatic adjustment of water temperature is achieved.

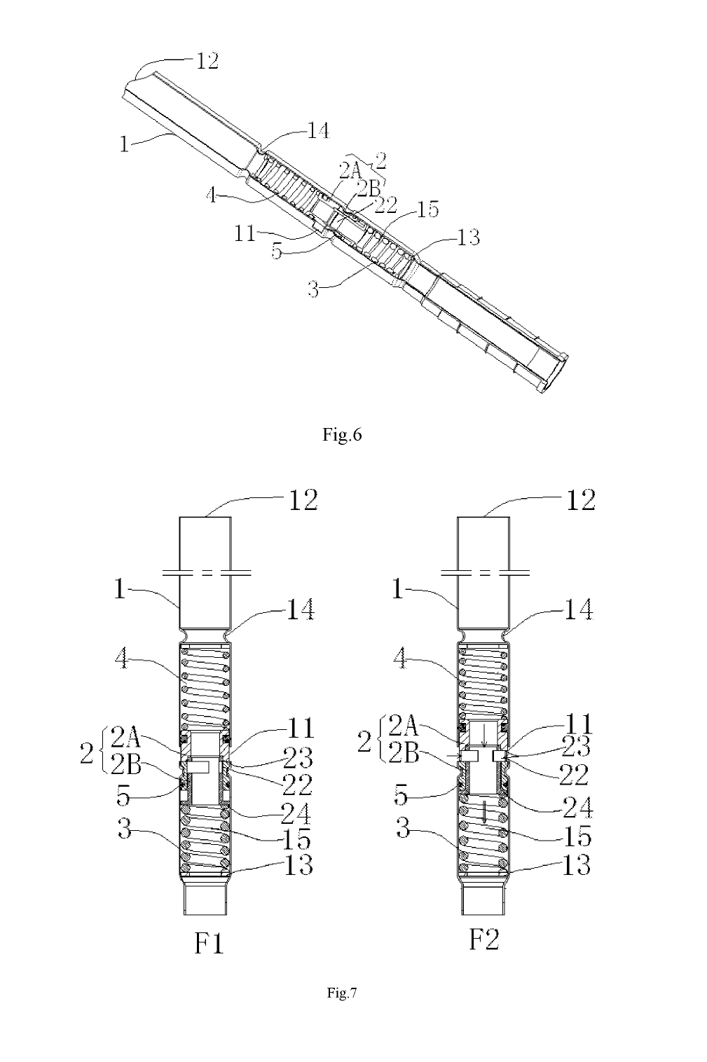

Refer to FIG. 6, which is a sectional view of Example 3 of the water outlet pipe assembly of this invention. Example 3 differs from Example 1 in that, the pipe body 1 is further provided with a stopper 5 and the stopper 5 can limit a range of the movement of the blocking element 2.

Refer to FIG. 7, which is a diagram showing the using state of Example 3 of the water outlet pipe assembly of this invention. In this Example 3, the blocking element 2 has a first part 2A for blocking the first water inlet 11 and a second part 2B provided with a through hole 22, an upper end of the first part 2A abuts against the elastic returning element 4 and its lower end is engaged with the second part 2B, and an upper end of the second part 2B is engaged with the first part 2A and its lower end abuts against the first thermosensitive element 3. When the blocking element 2 is in the second position 2F, the through hole 22 is at least partly communicated with the first water inlet 11.

Specifically, the first part 2A has a stopped surface 23 facing the stopper 5, and when the blocking element 2 is in the first position F1, the stopped surface 23 is stopped by the stopper 5.

An end of the second part 2B away from the first part 2A is formed with a peripheral flange 24; and when the blocking element 2 is in the second position 2F, the peripheral flange 24 is stopped by the stopper 5.

When the stopper 5 is used in cooperation with the blocking element 2, the first limiting portion 13 and the second limiting portion 14, it is possible to achieve a better control on a compression or elongation distance of the first thermosensitive element 3 and the elastic returning element 4, preventing them from excessive deformation and improving their durability, which helps to prolong a service life of the entire water outlet pipe assembly.

In addition, the first limiting portion 13 may be in a form of a circumferential projection inwardly formed on a pipe wall of the pipe body 1, or a step inwardly formed on a pipe wall of the pipe body 1, in the position of which a gasket is provided.

In practice, when the temperature of water flowing from the first water inlet 11 is higher and reaches a predetermined temperature, the first thermosensitive element 3 drives the blocking element 2 to move from the first position F1 towards the second position F2 to increase the opening of the first water inlet 11, and as the temperature goes down, the first thermosensitive element 3 drives the blocking element 2 to move from the second position F2 towards the first position F1 to reduce the opening of the first water inlet 11. The water outlet pipe assembly provided with the elastic returning element 4 in this invention can effectively ensure that the blocking element 2 could be returned accurately and therefore is highly reliable, on the premise that the function of automatic adjustment of water temperature is achieved.

Refer to FIG. 8, which is a schematic diagram showing the structure of Example 4 of the water outlet pipe assembly of this invention. Example 4 differs from Example 1 in that, another annular blocking element 6 is further disposed close to the second water inlet 12, and the annular blocking element 6 and the blocking element 2 are fixedly connected via a fastener 62, and when the blocking element 2 moves up and down, the annular blocking element 6 can make a synchronous movement.

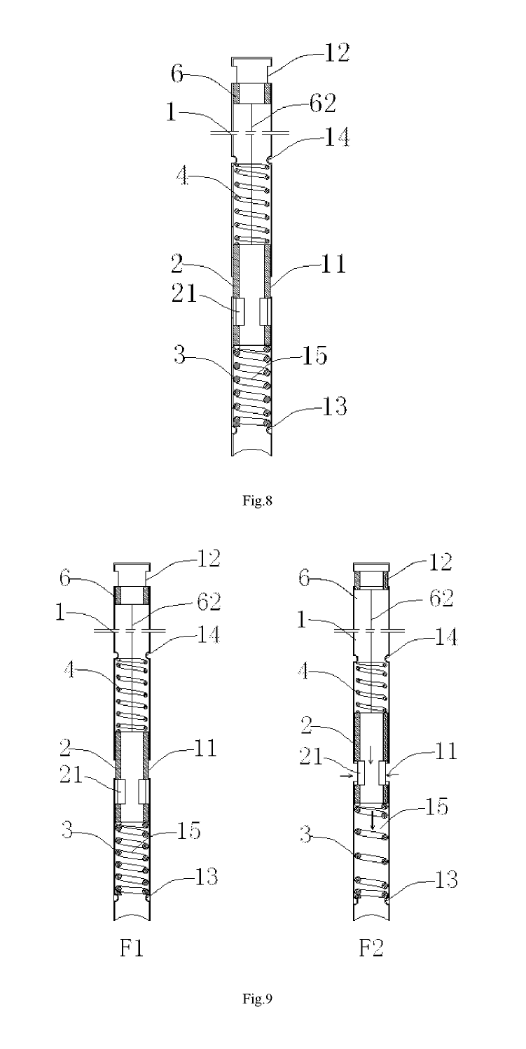

Refer to FIG. 9 as well, which is a diagram showing the using state of Example 4 of the water outlet pipe assembly of this invention. In practice, when the temperature of the water in the water tank is higher and reaches a predetermined temperature, the first thermosensitive element 3 drives the blocking element 2 to move from the first position F1 towards the second position F2 to increase the opening of the first water inlet 11 and reduce the opening of the second water inlet 12, and as the temperature goes down, the first thermosensitive element 3 drives the blocking element 2 to move from the second position F2 towards the first position F1 to reduce the opening of the first water inlet 11 and increase the opening of the second water inlet 12. The water outlet pipe assembly provided with the elastic returning element 4 in this invention can effectively ensure that the blocking element 2 could be returned accurately, and therefore is highly reliable, on the premise that the function of automatic adjustment of water temperature is achieved.

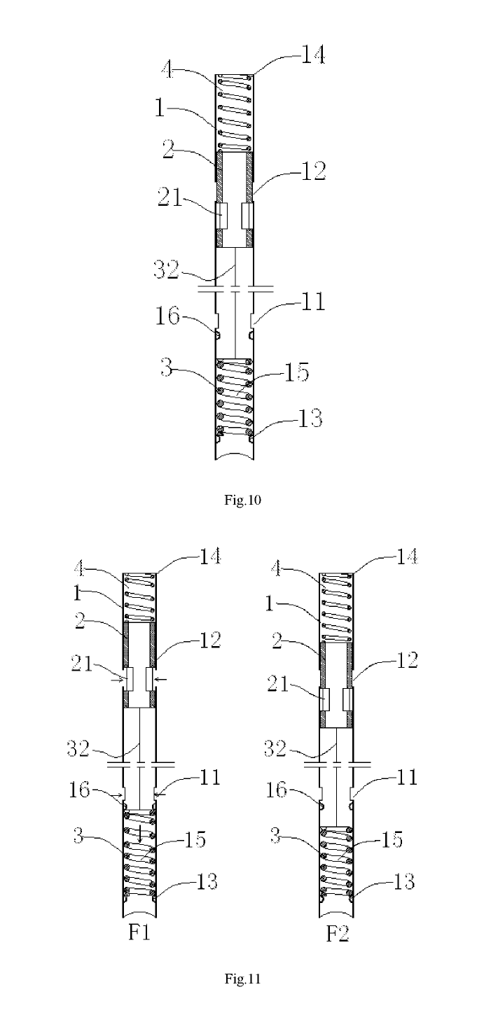

Refer to FIG. 10, which is a schematic diagram showing the structure of Example 5 of the water outlet pipe assembly of this invention. Example 5 differs from Example 1 in that, the first thermosensitive element 3 can drive the blocking element 2 to move so as to regulate an opening of the second water inlet 12 at a predetermined temperature.

The structure of Example 5 is formed so that the second water inlet 12 is located on a side wall on an upper portion of the pipe body 1, and the pipe body 1 is provided with a second limiting portion 14 on its top end, which is particularly a lid closing an upper end of the pipe body 1. The blocking element 2 is used for controlling an opening of the second water inlet 12, that is, controlling a rate of flow for hot water entering the pipe body 1. A connector 32 is provided between the first thermosensitive element 3 and the blocking element 2. The connector 32 is used for enabling the first thermosensitive element 3 to keep a synchronous motion with the blocking element 2. Further, a third limiting portion 16 may be provided on an upper portion of the first thermosensitive element 3, and particularly be a circumferential projection inwardly formed on a pipe wall of the pipe body 1. The third limiting portion 16 can be used in limiting a maximal expansion amount of the first thermosensitive element 3 so as to help the first thermosensitive element 3 to reliably operate in a displacement range desired by the blocking element 2.

Refer to FIG. 11, which is a diagram showing the using state of Example 5 of the water outlet pipe assembly of this invention. In practice, when the temperature of the water flowing from the first water inlet 11 is higher and reaches a predetermined temperature, the first thermosensitive element 3 drives the blocking element 2 to move from the first position F1 towards the second position F2 to reduce the opening of the second water inlet 12, and as the temperature goes down, the first thermosensitive element 3 drives the blocking element 2 to move from the second position F2 towards the first position F1 to increase the opening of the second water inlet 12. The water outlet pipe assembly provided with the elastic returning element 4 in this invention can effectively ensure that the blocking element 2 could be returned accurately and therefore is highly reliable, on the premise that the function of automatic adjustment of water temperature is achieved.

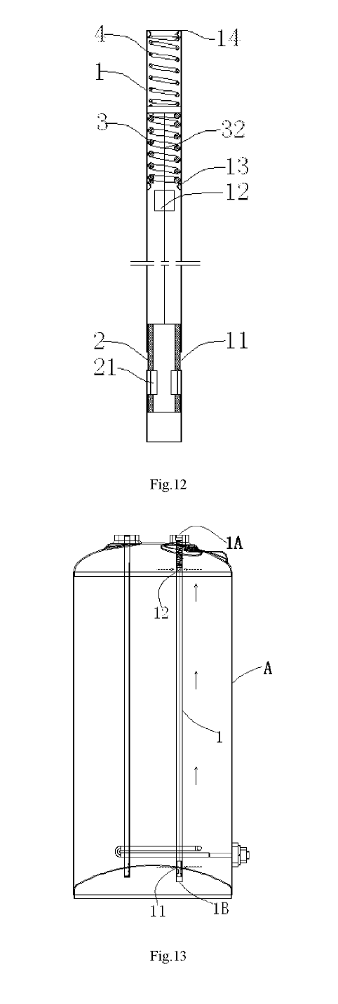

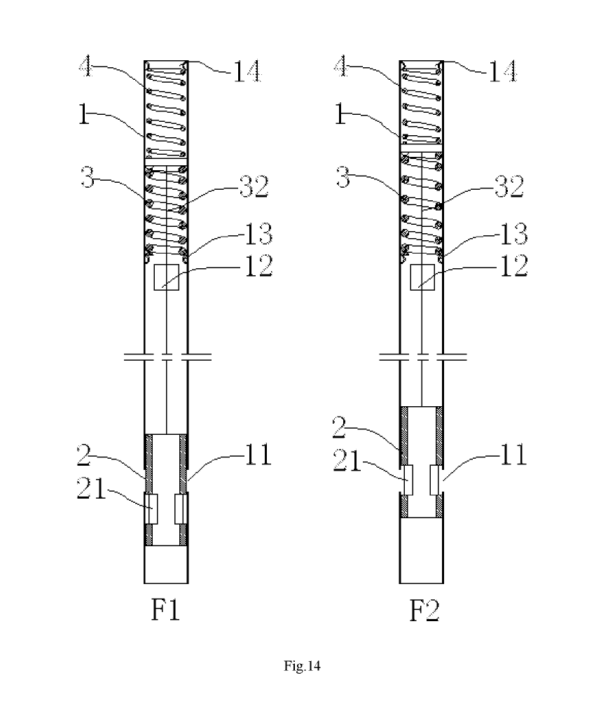

Refer to FIGS. 12 and 13, which are schematic diagrams showing the structure of Example 6 of the water outlet pipe assembly of this invention and its installation in a liner, respectively. As shown in FIG. 12, the liner A is of a vertical structure. Example 6 differs from Example 1 mainly in that the water outlet pipe assembly is in a form of up drain. The pipe body 1 is provided with a mounting end 1A capable of being connected with the liner A and a free end 1B capable of extending into the liner A. An installation position of the installation end 1A is located above the liner A as an open end for flowing out a water in constant temperature. The free end 1B is located beneath the liner A as a closed end.

A first water inlet 11 is provided in a position of the pipe body 1 close to a lower portion of the liner A, and the first water inlet 11 enables cold water from the lower portion of the liner A to enter the pipe body 1; a second water inlet 12 is provided in a position of the pipe body 1 close to an upper portion of the liner A, and the second water inlet 12 is located on a side wall of the pipe body 1, and enables hot water in the upper portion of the liner A to enter the pipe body 1; a blocking element 2 is movably provided on the pipe body 1 and a first thermosensitive element 3 is provided on the pipe body 1, and the first thermosensitive element 3 can drive the blocking element 2 to move at a predetermined temperature so as to regulate an opening of the first water inlet 11, i.e., capable of regulating a rate of flow for cold water entering the pipe body 1; and an elastic returning element 4 is provided on the pipe body 1, and the elastic returning element 4 can apply a force to the blocking element 2 for returning the blocking element 2.

The blocking element 2 is of cylindrical shape, and sleeved inside the pipe body 1, and the blocking element 2 is provided with an opening 21. When the blocking element 2 is in a first position F1, the blocking element 2 completely blocks the first water inlet 11; and when the blocking element 2 is in a second position F2, the opening 21 is at least partly communicated with the first water inlet 11.

The pipe body 1 is provided with a first limiting portion 13 limiting the first thermosensitive element 3 and located in a position above the second water inlet 12. The pipe body 1 is provided with a second limiting portion 14 limiting the elastic returning element 4 and located in the top position of the pipe body 1. The first limiting portion 13 and the second limiting portion 14 may particularly be circumferential projections inwardly formed on a pipe wall of the pipe body 1. Since the first limiting portion 13 and the second limiting portion 14 are respectively provided on the pipe body 1, it facilitates to accurately control a compression or elongation distance of the first thermosensitive element 3 and the elastic returning element 4, preventing them from excessive deformation and improving durability, which helps to prolong a service life of the entire water outlet pipe assembly.

A connector 32 is provided between the first thermosensitive element 3 and the blocking element 2. The first thermosensitive element 3 and the blocking element 2 are fixedly connected by the connector 32 so that the blocking element 2 can make a synchronous movement as the first thermosensitive element 3 deforms and stretches up and down.

Refer to FIG. 14, which is diagram showing the using state of Example 6 of the water outlet pipe assembly of this invention. In practice, when the temperature of water flowing from the second water inlet 12 is higher and reaches a predetermined temperature, the first thermosensitive element 3 drives the blocking element 2 to move from the first position F1 towards the second position F2 to increase the opening of the first water inlet 11, and as the temperature goes down, the first thermosensitive element 3 drives the blocking element 2 to move from the second position F2 towards the first position F1 to reduce the opening of the first water inlet 11. The water outlet pipe assembly provided with the elastic returning element 4 in this invention can effectively ensure that the blocking element 2 could be returned accurately and therefore is highly reliable, on the premise that the function of automatic adjustment of water temperature is achieved.

In summary, the water outlet pipe assembly with the elastic returning element 4 in this invention can effectively ensure that the blocking element 2 could be returned accurately and therefore is highly reliable over the existing drainage device, on the premise that the function of automatic adjustment of water temperature is achieved. In addition, limiting portions matching the elastic returning element 4 are further provided in corresponding positions of the pipe body 1 for a better control on a compression or elongation distance of the first thermosensitive element 3 and the elastic returning element 4, preventing them from excessive deformation and improving durability, which helps to prolong a service life of the entire water outlet pipe assembly.

In addition, this invention is simple in structure and cost effective, a water outflowing at constant-temperature can be realized not only by controlling an opening of the first water inlet 11 for mixing a cold water in a hot water, but also by controlling an opening of the second water inlet 12 for mixing a hot water in a cold water, or even by controlling the openings of both the first water inlet 11 and the second water inlet 12.

Those Examples mentioned above are only several examples of the invention. Although the Examples of the invention are illustrated as above, the contents thereof are only embodiments used to facilitate a better understanding of the invention and are not intended to limit the invention. Those skilled in the art could conceive any modification or variation in form and in detail of the embodiments without departing from the spirit and scope of this invention, though the protection scope of this invention should be defined by the appended claims.

1. A water outlet pipe assembly for installation in a liner of a water heater, characterized by comprising:
a pipe body provided with a mounting end capable of being connected with the liner and a free end capable of extending into the liner, wherein a first water inlet is provided at a position of the pipe body close to a lower portion of the liner and enables the water in the lower portion of the liner to enter the pipe body, and a second water inlet is provided at a position of the pipe body close to an upper portion of the liner and enables the water in the upper portion of the liner to enter the pipe body;
a blocking element movably provided on the pipe body and a first thermosensitive element provided on the pipe body, the first thermosensitive element can drive the blocking element to move at a preset temperature so as to regulate an opening of the first water inlet and/or the second water inlet; and
an elastic returning element provided on the pipe body, the elastic returning element can apply a force to the blocking element for returning the blocking element.

2. The water outlet pipe assembly according to claim 1, characterized in that, the blocking element has a first position completely blocking the first water inlet and a second position at least partly opening the first water inlet; the first thermosensitive element can drive the blocking element to move between the first position and the second position; and the elastic returning element can apply the force towards the first position to the blocking element.

3. The water outlet pipe assembly according to claim 2, characterized in that, the blocking element is of hollow structure and is sleeved with the pipe body.

4. The water outlet pipe assembly according to claim 2, characterized in that, the pipe body is provided with a stopper which can limit a range of the movement of the blocking element.

5. The water outlet pipe assembly according to claim 3 or 4, characterized in that, the blocking element is of cylindrical shape, provided with an opening; when the blocking element is in the first position, the blocking element completely blocks the first water inlet, and when the blocking element is in the second position, the opening is at least partly communicated with the first water inlet.

6. The water outlet pipe assembly according to claim 4, characterized in that, the blocking element has a first part for blocking the first water inlet, and a second part provided with a through hole; and when the blocking element is in the second position, the through hole is at least partly communicated with the first water inlet.

7. The water outlet pipe assembly according to claim 6, characterized in that, the first part has a stopped surface facing the stopper, and when the blocking element is in the first position, the stopped surface is stopped by the stopper.

8. The water outlet pipe assembly according to claim 7, characterized in that, an end of the second part away from the first part is formed with a peripheral flange; and when the blocking element is in the second position, the peripheral flange is stopped by the stopper.

9. The water outlet pipe assembly according to claim 2, characterized in that, the blocking element, the first thermosensitive element and the elastic returning element are all provided at interior or exterior of the pipe body.

10. The water outlet pipe assembly according to claim 1, characterized in that, the first thermosensitive element is a thermosensitive spring.

11. The water outlet pipe assembly according to claim 10, characterized in that, the thermosensitive spring is provided on a portion for mixing hot water and cold water of the pipe body.

12. The water outlet pipe assembly according to claim 10, characterized in that, the thermosensitive spring is of a material of nickel-titanium alloy or nickel-titanium-copper alloy.

13. The water outlet pipe assembly according to claim 1, characterized in that, the first thermosensitive element is of a material of thermosensitive polymer.

14. The water outlet pipe assembly according to claim 2, characterized in that, the elastic returning element is a return spring whose elastic coefficient is a constant.

15. The water outlet pipe assembly according to claim 14, characterized in that, when the blocking element is in the second position, the elastic coefficient of the return spring is less than that of the first thermosensitive element.

16. The water outlet pipe assembly according to claim 2, characterized in that, the elastic returning element is a second thermosensitive element.

17. The water outlet pipe assembly according to claim 2, characterized in that, the first thermosensitive element is disposed at a position close to the first water inlet, or the first thermosensitive element is disposed at a position close to the second water inlet.

18. The water outlet pipe assembly according to claim 17, characterized in that, a connector is provided between the first thermosensitive element and the blocking element.

19. The water outlet pipe assembly according to claim 2, characterized in that, the pipe body is provided with a first limiting portion limiting the first thermosensitive element, and the first thermosensitive element is provided between the first limiting portion and the blocking element; the pipe body is provided with a second limiting portion limiting the elastic returning element, and the elastic returning element is provided between the second limiting portion and the blocking element.
